(19) United States
(12) Patent Application Publication
(10) Pub. No.: US 2005/0225453 A1
(43) Pub. Date: Oct. 13, 2005

(54) Method and apparatus for controlling device using three-dimensional pointing

(75) Inventors: Wook Chang, Seoul (KR); Dong-yoon Kim, Seoul (KR); Jong-koo Oh, Yongin-si (KR); Won-chul Bang, Seongnam-si (KR); Kyoung-ho Kang, Yongin-si (KR); Sung-jung Cho, Suwon-si (KR); Jing Yang, Yongin-si (KR); Eun-seok Choi, Anyang-si (KR); Joon-kee Cho, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/044,059

(22) Filed: Jan. 28, 2005

(30) Foreign Application Priority Data
Apr. 10, 2004 (KR) 2004-24736

(51) Int. Cl. G08C 19/00; G06F 3/00; G06F 9/00

(52) U.S. Cl. 340/825.69; 715/863

(57) ABSTRACT

A method for controlling a predetermined control-targeted device using three dimensional pointing, wherein the method includes: calculating position information of a controlling apparatus; calculating attitude information of a controlling apparatus; calculating sight line information of the controlling apparatus by using the position information and the attitude information of the controlling apparatus; selecting the predetermined control-targeted device by using the sight line information of the controlling apparatus; and controlling the selected control-targeted device.

### BACKGROUND OF THE INVENTION

This application claims priority from Korean Patent Application No. 2004-24736, filed on Apr. 10, 2004 in the Korean Intellectual Property Office, the disclosure of which is incorporated herein in its entirety by reference.

1. Field of the Invention

The present invention relates to a method and apparatus for controlling a device using three-dimensional (3D) pointing, and more particularly, to a method and apparatus for controlling a device using 3D pointing by pointing a control targeted device, which a user intends to control, among a plurality of control targeted devices.

2. Description of the Related Art

A controlling system is being currently used to control a control-targeted device through a controlling apparatus such as a remote controller and the like at a home or an office. In the controlling system, the control-targeted device such as telephone, television set, air conditioner and the like is increased by geometric progression. The plurality of control-targeted devices include each of the controlling apparatuses. As the number of control-targeted devices is increased, the number of the controlling apparatuses is also increased. In the environment of the controlling system, there is an inconvenience in that the user of the control-targeted device can confuse the controlling apparatus of each of the control-targeted devices, and should adapt to a plurality of controlling apparatuses.

In order to solve this inconvenience, an integrated controlling method is used to integrate and control the plurality of control-targeted devices. In a conventional integrated controlling method, a control-targeted device selecting button installed at the integrated controlling apparatus is used to select a control-targeted device, which the user intends to control, and control the selected control-targeted device by using a function button for the selected control-targeted device. In another conventional integrated controlling method, a plurality of control-targeted devices are displayed on the touch screen of the integrated controlling apparatus and the control-targeted device is selected among the plurality of displayed control-targeted devices. Additionally, functions corresponding to the selected control-targeted device are displayed on the touch screen of the integrated controlling apparatus and a predetermined function for the selected control-targeted device is selected to control the control-targeted device.

In the conventional integrated controlling methods, the plurality of control-targeted devices can be controlled in case where the control-targeted device, which the user intends to control, is small in number. However, in case where there is a large number of the control-targeted devices, there is a drawback in that a large number control-targeted device selecting buttons should be disposed at the controlling apparatus or a large number of control-targeted devices should be displayed on the touch screen of the controlling apparatus. The conventional integrated controlling method has a limitation in which a gradually miniaturized controlling apparatus includes a plurality of selecting buttons or display the plurality of control-targeted devices, and still has a drawback in that the user can confuse the control-targeted devices.

A controlling method for recognizing a user's hand operation by using a plurality of cameras installed indoor to select the control-targeted device corresponding to a pattern of the hand operation and controlling a function of selected control-targeted device is known in the art. However, there is a drawback in that the plurality of cameras should be installed to embody the controlling method, and a high-priced computer is required to recognize the hand operation and analyze the pattern of the hand operation.

In the meantime, a controlling method for acknowledging a position of a controlling apparatus by using an RF signal to control the control-targeted device disposed at a periphery of the controlling apparatus is known in the art. However, the method has a drawback in that only control-targeted device disposed at the periphery of the controlling apparatus can be controlled.

In the meantime, a controlling method for controlling a main remote controlling system to indirectly control a plurality of control-targeted devices by using another remote controller possessed by a user in the main remote controlling system installed indoors for controlling the plurality of control-targeted devices. However, this controlling method has an inconvenience in that the user should directly input angle information between the main remote controlling system and the control-targeted devices, and has a drawback in that intuition is degraded when the control-targeted device is controlled.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non- limiting embodiment of the present invention may not overcome any of the problems described above.

The present invention provides a simple and low-priced method and apparatus for controlling a device using a 3D pointing by pointing a control targeted device, which a user intends to control, among a plurality of control targeted devices.

Also, the present invention provides a system for controlling a device using a 3D pointing by pointing a control targeted device, which a user intends to control, among a plurality of control targeted devices.

According to an aspect of the present invention, there is provided a method for controlling a predetermined control-targeted device using a 3D (three dimensional) pointing. The method includes: calculating position information of a controlling apparatus; calculating attitude information of a controlling apparatus; calculate sight line information of the controlling apparatus by using the position information and the attitude information of the controlling apparatus; selecting the predetermined control-targeted device by using the sight line information of the controlling apparatus; and controlling the selected control-targeted device.

In the calculating of the position information, a wireless communication protocol Ultra Wide Band (UWB) is used to calculate the position information of the controlling apparatus.

The selecting of the predetermined control-targeted device includes: receiving position information of the control-targeted device; calculating a distance between a sight line of the controlling apparatus and the control-targeted device by using the position information of the control-targeted device; and detecting a predetermined control-targeted device that is positioned at the closest distance to the controlling apparatus.

According to another aspect of the present invention, the selecting of the predetermined control-targeted device includes: receiving the position information of the control-targeted device; calculating a distance between a sight line of the controlling apparatus and the control-targeted device by using the position information of the control-targeted device; firstly selecting candidate control-targeted devices positioned within a predetermined distance from a sight line of the controlling apparatus; and secondly selecting a control-targeted device, which a user intends to control, among the firstly selected control-targeted devices.

The secondly selecting includes: measuring a motion of the controlling apparatus; and secondly selecting a control-targeted device corresponding to the measured motion of the controlling apparatus, among the firstly selected control-targeted devices.

According to a further another aspect of the presents invention, the controlling includes: obtaining functions corresponding to the selected control-targeted device; displaying the obtained functions on the displaying unit of the controlling apparatus; selecting a specific function among the displayed functions; generating a control signal corresponding to the selected function; and transmitting the generated control signal to the selected control-targeted device.

According to a still another aspect of the present invention, there is provided an apparatus for controlling a predetermined control-targeted device using a 3D (three dimensional) pointing, the apparatus including: a position calculating unit which calculates position information of the controlling apparatus; an attitude calculating unit which calculates attitude information of the controlling apparatus; a sight-line calculating unit which calculates sight-line information of the controlling apparatus by using the position information and the attitude information of the controlling apparatus; a control-targeted device selecting unit which selects the control-targeted device by using the sight line information of the controlling apparatus; and a controlling unit which controls the selected control-targeted device.

The control-targeted device selecting unit includes: a storage media which stores position information of the control-targeted device; a distance calculating unit which calculates a distance from a sight line of the controlling apparatus to the control-targeted device by using the position information of the control-targeted device; and a control-targeted device detecting unit which detects a predetermined control-targeted device disposed at the closest distance from the sight line of the controlling apparatus by using the calculated distance.

The controlling unit includes: a displaying unit which displays a control state of the controlling apparatus; a storage media which stores functions of the control-targeted devices and control signal data corresponding to the functions; a control signal generating unit which generates a control signal by using the control signal data corresponding to a predetermined function of the control-targeted device; and a processor unit which controls the displaying unit, the storage media and the control signal generating unit.

### BRIEF DESCRIPTION OF THE DRAWINGS

The above and other aspects of the present invention will become more apparent by describing in detail exemplary embodiments thereof with reference to the attached drawings in which:

FIG. 1 is a schematic view illustrating an integrated control system including a control apparatus and a plurality of control-targeted devices according to an exemplary embodiment of the present invention;

FIG. 2 is a block diagram illustrating an apparatus for controlling a device using a 3D pointing according to an exemplary embodiment of the present invention;

FIG. 3 is a flowchart illustrating a process of selecting and controlling a control-targeted device, which a user intends to control, among a plurality of control-targeted devices according an exemplary embodiment of the present invention;

FIG. 4 is a more detailed flowchart illustrating a process of calculating position information of a controlling apparatus;

FIG. 5 is a more detailed flowchart illustrating a process of selecting a control-targeted device;

FIG. 6 is a flowchart illustrating a process of selecting a control-targeted device according another exemplary embodiment of the present invention;

FIG. 7 is a flowchart illustrating a process of secondly selecting a control-targeted device among candidate control-targeted devices on the basis of a motion of a controlling apparatus according to another exemplary embodiment of the present invention;

FIG. 8 is a diagram illustrating an exemplary process of secondly selecting a control-targeted device on the basis of a motion of a controlling apparatus, correspondingly to the flowchart of FIG. 7;

FIG. 9A is a flowchart illustrating a method of generating a control signal by a motion pattern of a controlling apparatus;

FIG. 9B is a view illustrating an exemplary motion pattern, which can be used in a method of generating a control signal by the motion pattern;

FIG. 10 is a flowchart illustrating a method of generating a predetermined control signal by using a displaying unit of a controlling apparatus;

FIG. 11 is a system for controlling a device using a 3D pointing, including an apparatus for controlling the device using the 3D pointing, a home server and a remote controller; and

FIG. 12 is a flowchart illustrating a method for transmitting a control signal to a predetermined control-targeted device in a system for controlling a device using a 3D pointing of FIG. 11.

### DETAILED DESCRIPTION OF THE ILLUSTRATIVE, NON-LIMITING EMBODIMENTS OF THE INVENTION

The attached drawings illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

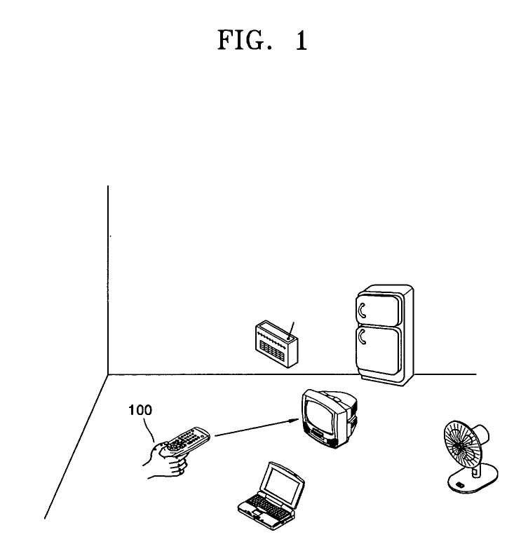

FIG. 1 is a schematic view illustrating an integrated control system including a control apparatus and a plurality of control-targeted devices according to an exemplary embodiment of the present invention.

Referring to FIG. 1, the inventive integrated controlling system includes a plurality of control-targeted devices (e.g., device 1, device 2, . . . , device n) such as an audio system, a television set, an electric fan and the like; and a controlling apparatus 100 such as a remote controller. In the integrated controlling system, a user points at and selects the control-targeted deice, which the user intends to control, among the plurality of control-targeted devices (device 1, device 2, . . . , device n) by using the controlling apparatus 100.

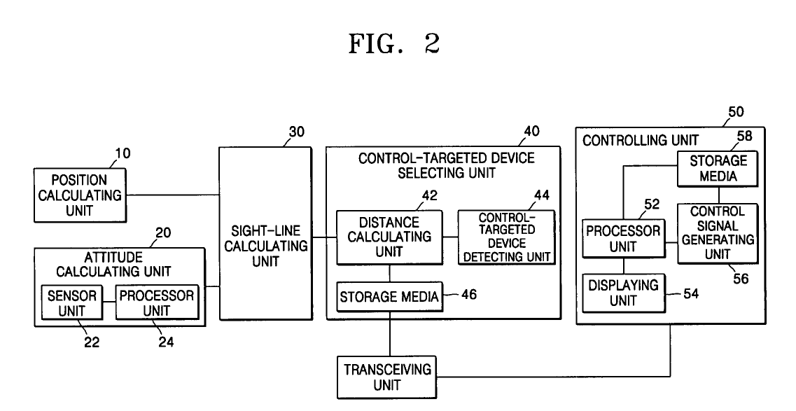

FIG. 2 is a block diagram illustrating the controlling apparatus 100 for controlling a device using a 3D pointing according to an exemplary embodiment of the present invention.

The controlling apparatus 100 includes a position calculating unit 10, a attitude calculating unit 20, a sight-line calculating unit 30, a control-targeted device selecting unit 40 and a controlling unit 50.

The position calculating unit 10 calculates position information of the controlling apparatus 100 with respect to a specific reference point of an indoor space. A study is being vigorously performed for a method for calculating position information of a predetermined device in a predetermined space. As an example of a method for measuring a position of a control-targeted device in a predetermined space, a sensor array or a wireless communication way such as IEEE 802.11b, UWB bluetooth can be used to calculate the position information of the control-targeted device.

A method using the sensor array is a method for calculating position information of the control-targeted device by using a sensor array previously installed at a ceiling or floor. That is, in this method, an Radio Frequency Identification (RFID) reader is disposed at the ceiling and an RFID tag is attached to each of the control-targeted devices such that installed sensors are used to measure a strength of a signal received from each of the RFID tag, thereby recognizing a position of the control-targeted device.

Another method for measuring the position of the control-targeted device in the indoor space uses a wireless communication protocol such as IEEE 802.11b, UWB, Bluetooth. In this position measuring method, radio wave is received form several fixed devices for transmitting the radio wave into the indoor space. As a known method for measuring the position using the wireless communication protocol, there are Received Signal Strength (RSS), Angle of Arrival (AoA), Time of Arrival (ToA), Time Differences of Arrival (TDoA) and the like. The UWB is a strong candidate, among the wireless communication protocols, for a wireless communication way of future home appliances. In the present invention, the UWB may be used to measure the position of the control-targeted device.

The attitude calculating unit 20 includes a sensor unit 22 and a processor unit 24 and calculates attitude information of the controlling apparatus. The sensor unit 22 may include a three-axis acceleration sensor and a three-axis terrestrial magnetism sensor. The sensor unit 22 can obtain attitude information of the controlling apparatus without an external additional system. The three-axis acceleration sensor measures an acceleration value on an X-axis, a Y-axis and a Z-axis of the controlling apparatus 100, and the three-axis terrestrial magnetism sensor measures a terrestrial magnetism value on the X-axis, the Y-axis and the Z-axis of the controlling apparatus 100.

The processor unit 24 uses the values measured at the three-axis acceleration sensor and the three-axis terrestrial magnetism sensor to calculate direction information of the controlling apparatus, which is expressed as an Eular angle. The processor unit 24 uses a three-axis acceleration value measured in the three-axis acceleration sensor to calculate a roll angle and a pitch angle of the controlling apparatus 100. Further, the processor unit 24 uses the roll angle and the pitch angle of the controlling apparatus 100 and the terrestrial magnetism value of the controlling apparatus, which is measured in the three-axis terrestrial magnetism sensor to calculate a Yaw angle of the controlling apparatus 100.

The sight-line calculating unit 30 uses the position information and the attitude information of the controlling apparatus 100 calculated in the position calculating unit 10 and the attitude calculating unit 20 to calculate sight line information pointed by the controlling apparatus 100.

The control-targeted device selecting unit 40 includes a distance calculating unit 42, a control-targeted device detecting unit 44 and a storage media 46. The storage media 46 stores the position information of the plurality of control-targeted devices disposed in the integrated controlling system. The position information of the control-targeted devices can be calculated in the aforementioned position information calculating method. The position information of the control-targeted devices is transmitted from each of the control-targeted devices to the controlling apparatus 100 for storage or is transmitted from a home server having the position information of each of the control-targeted device to the controlling apparatus 100 for storage.

The distance calculating unit 42 uses the position information of the plurality of control-targeted device, which are stored in the storage media 46 and the sight-line information of the controlling apparatus 100 calculated in the sight-line calculating unit 30, to calculate a distance between the control-targeted devices and the sight line of the controlling apparatus. The control-targeted device detecting unit 44 uses the distance between the control-targeted devices and the sight line of the controlling apparatus, to detect the control-targeted device positioned at a distance, which is the closest from the sight line of the controlling apparatus 100.

The controlling unit 50 includes a processor unit 52, a displaying unit 54, a control signal generating unit 56 and a storage media 58. The storage media 58 stores functions of all control-targeted devices, which can be selected by the controlling apparatus 100, and their corresponding control signal data. The displaying unit 54 displays a control state of the controlling apparatus 100. In a case where the displaying unit is a touch screen, the user can input a control command through the touch screen, the processor unit 52 extracts the function corresponding to the control-targeted device selected by the control-targeted device selecting unit 40 and the control signal data. If a specific function for the control-targeted device is selected, the processor unit 52 uses the control signal data corresponding to the specific function to allow a control signal generating unit 56 to generate a control signal.

The controlling apparatus 100 may include a transceiver 60. Through the transceiver 60, the position information of the control-targeted device is received and the generated control signal is transmitted from the controlling apparatus.

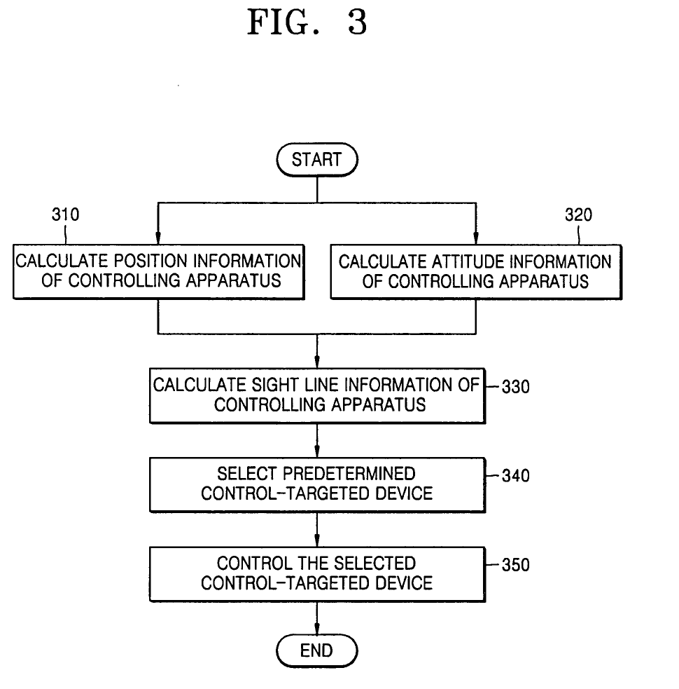

FIG. 3 is a flowchart illustrating a process of selecting and controlling a control-targeted device, which a user intends to control, among a plurality of control-targeted devices according an exemplary embodiment of the present invention.

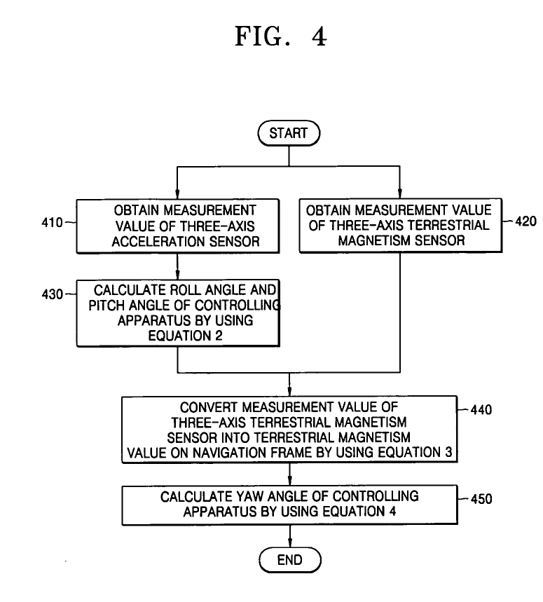

In operations 310 and the 320, the position information and the attitude information of the controlling apparatus are calculated. Operation 320 will be described in more detail later with reference to FIG. 4. In operation 330, the position information and the attitude information of the controlling apparatus calculated in operations 310 and the 320 are used to calculate the sight-line information of the controlling apparatus 100. A sight-line unit vector of the controlling apparatus 100 is calculated as follows in Equation 1. Here, it is assumed that the sight-line unit vector of the controlling apparatus 100 is in parallel with a Z-axis direction of a body frame of the controlling apparatus 100. The sight line is not necessarily consistent with a specific axis of the controlling apparatus.

$${I}_{Line\_Of \_Sight} = C ( ϕ , θ , Ψ ) [ \begin{matrix}0 \\ 0 \\ 1\end{matrix} ] \qquad [ Equation 1 ]$$

where I_{Line}_{_{—}}_{of —}_{sight} is a sight line vector of the controlling apparatus 100, C(Φ,θ,ψ) is a directional cosine matrix of 3×3 dimension, and

$$[ \begin{matrix}0 \\ 0 \\ 1\end{matrix} ]$$

is a Z-axis unit vector of the controlling apparatus 100 viewed from the body frame.

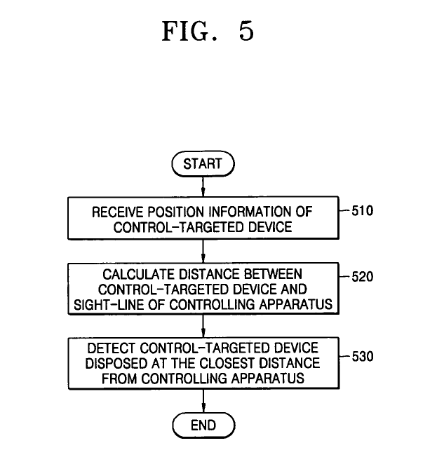

The body frame of the controlling apparatus 100 is converted into a navigation frame through the directional cosine matrix. In operation 340, the sight-line information of the calculated controlling apparatus 100 and the position information of the control-targeted device are used to select a predetermined control-targeted device. Hereinafter, operation 340 is in more detail described with reference to FIGS. 5 through 8. In operation 350, the control signal for the selected control-targeted device is generated to control the selected control-targeted device.

FIG. 4 is a more detailed flowchart illustrating operation 320 of FIG. 3, that is, a process of calculating the position information of the controlling apparatus. In operation 410 and 420, a three-axis acceleration value and a three-axis terrestrial magnetism value of the controlling apparatus are obtained through the three-axis acceleration sensor and the three-axis terrestrial magnetism sensor. In operation 430, the three-axis acceleration value of the controlling apparatus calculated in operation 410 is applied to the following Equation 2 to calculate the roll angle φ and the pitch angle θ of the controlling apparatus.

$$[ \begin{matrix}ϕ \\ θ\end{matrix} ] = [ \begin{matrix}arctan 2 ( - {A}_{by}^{s} , - {A}_{bz}^{s} ) \\ arctan 2 ( {A}_{bx}^{s} , \sqrt{{( {A}_{by}^{s} )}^{2} + {( {A}_{bz}^{s} )}^{2}}\end{matrix} ] \qquad [ Equation 2 ]$$

where Abₛ^{bx}, Aₛ^{by, A}ₛ^{bz} is a gravitational acceleration measured on X-axis, Y-axis, Z-axis.

In operation 440 process, the three-axis terrestrial value of the controlling apparatus in the obtained in operation 420 is applied to the following Equation 3 to convert the three-axis terrestrial magnetism value on the body frame into the three-axis terrestrial magnetism value on the navigation frame.

$$[ \begin{matrix}{M}_{nx} \\ {M}_{ny} \\ {M}_{nz}\end{matrix} ] = [ \begin{matrix}cos θ & sin θ sin ϕ & sin θcos ϕ \\ 0 & cos ϕ & - sin ϕ \\ - sin θ & cos θsinϕ & cos θcosϕ\end{matrix} ] [ \begin{matrix}{M}_{bx} \\ {M}_{by} \\ {M}_{bz}\end{matrix} ] \qquad [ Equation 3 ]$$

where M_{bx}, M_{by}, M_{bz} are X-axis, Y-axis and Z-axis terrestrial magnetism values of the controlling apparatus measured in the three-axis terrestrial magnetism sensor, and Mₙₓ, M_{ny}, M_{nz} are terrestrial magnetism values of the measured terrestrial magnetism values on the navigation frame.

The navigation frame is a virtual coordinate having three axes set to respectively indicate North, East, and Earth. In operation 450 process, the terrestrial magnetism value on the navigation frame calculated in operation 440 is applied to the following Equation 4 to calculate the Yaw angle Ψ of the controlling apparatus 100.

$$Ψ = {tan}^{- 1} ( \begin{matrix}- {M}_{ny} \\ {M}_{nx}\end{matrix} ) \qquad [ Equation 4 ]$$

FIG. 5 is a more detailed flowchart illustrating operation 340 of FIG. 3, that is, a process of selecting the control-targeted device.

In operation 510, the position information of the control-targeted device is received. The position information of the control-targeted device is received from each of the control-targeted device or is received from the home server for storing the position information of the control-targeted device. In operation 520, the position information of the control-targeted device and the sight-line information of the controlling apparatus 100 are used to calculate the distance the control-targeted device and the sight line of the controlling apparatus 100. The distance between the control-targeted device and the sight line of the controlling apparatus 100 is calculated through the following Equation (5).

$${D}_{i} = \frac{\vert QR \times {P}_{i} Q \vert}{\vert QR \vert} \qquad [ Equation 5 ]$$

where Dᵢ is as shortest distance between i^{th} control-targeted device and the sight line of the controlling apparatus 100, Q and R are prederermined points positioned on the sight line of the controlling apparatus 100, Pᵢ is a position of i^{th} control-targeted device, and QR and QPᵢ are vectors.

A position information of the predetermined point existing on the sight line of the controlling apparatus 100 can be obtained from the following Equation 6
P_{LOS}=Pᵣₑₘₒₜₑ+1_{Line}_{_{—}}_{of}_{_{—}}_{Sight} [Equation]6
where Pᵣₑₘₒₜₑ is a position of the controlling apparatus, and a is a predetermined real number.

In operation 530, the control-targeted device, which is at the distance closest to the sight line of the controlling apparatus 100 among the distances between the control-targeted device and the controlling apparatus 100 calculated in operation 520, is detected. The control-targeted device, which is the closest to the sight line of the controlling apparatus 100, is selected.

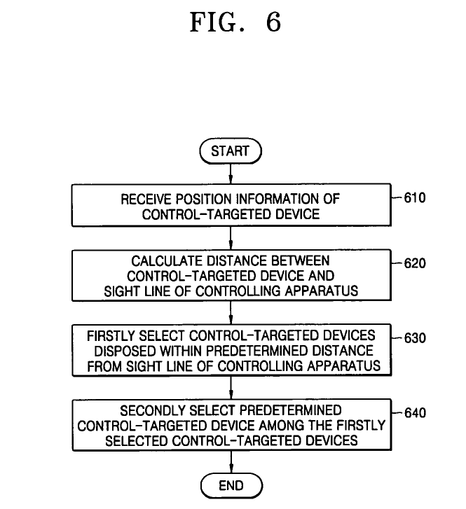

FIG. 6 is a flowchart illustrating operation 340 of FIG. 3, that is, a process of selecting the control-targeted device according another exemplary embodiment of the present invention. In operation 610, the position information of the control-targeted information is received. In operation 620, the distance between the control-targeted device and the sight line of the controlling apparatus 100 is calculated. Operations 610 and the 620 are the same as operations 510 and 520 in FIG. 5. In operation 630, candidate control-targeted devices disposed within a predetermined distance from the sight line of the controlling apparatus 100 are firstly selected. As shown as follows in Algorithm 1 for firstly selecting the candidate control-targeted device , the predetermined distance can be appropriately controlled depending on an appliance environment of the present invention.
FOR i=1:N [Algorithm 1]

Calculate Di

IF Di<Dt, where Dt is the preferred threshold value
Store i in candidate list

END IF

END FOR

The candidate control-targeted devices firstly selected by the Algorithm 1 may be displayed on the displaying unit 54 of the controlling apparatus 100. In operation 640 process, a predetermined control-targeted device is secondly selected among the firstly selected candidate-targeted devices. The second selection can be performed using a select-button, joystick, jog/shuttle, touch-screen inputting way, which is employed in general controlling apparatuses.

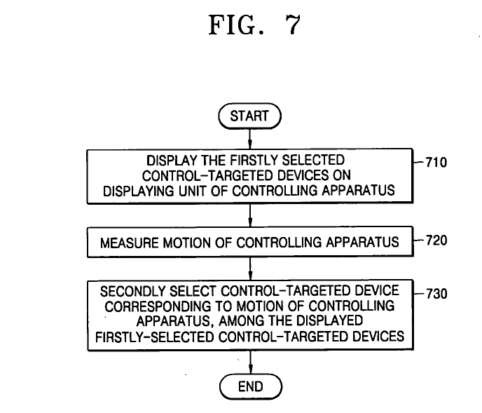

FIG. 7 is a flowchart illustrating a process of secondly selecting the control-targeted device among the candidate control-targeted devices on the basis of a motion of the controlling apparatus according to another exemplary embodiment of the present invention.

In operation 710, the firstly selected candidate control-targeted devices are displayed on the displaying unit 54 of the controlling apparatus 100. In operation 720, the motion of the controlling apparatus is measured. The motion of the controlling apparatus 100 can be measured through the sensor unit 22. Further, in order to measure a relative motion of the controlling apparatus 100, a gyro-sensor can be provided, and is included within a scope of the present invention. In operation 730, the control-targeted device corresponding to the motion of the controlling apparatus 100 among the displayed candidate control-targeted devices is secondly selected. The control-targeted device corresponding to the motion of the controlling apparatus 100 can be displayed on the displaying unit 54. When the control-targeted device, which the user intends to control, is displayed, the user can select the control-targeted device using the select button and the like. The second selection process based on the motion, which is illustrated in FIG. 7, provides a controlling method for more precisely selecting the control-targeted device, which the user intends to control, among the candidate control-targeted devices disposed at a periphery of the sight line of the controlling apparatus 100, on the basis of the motion of the controlling apparatus.

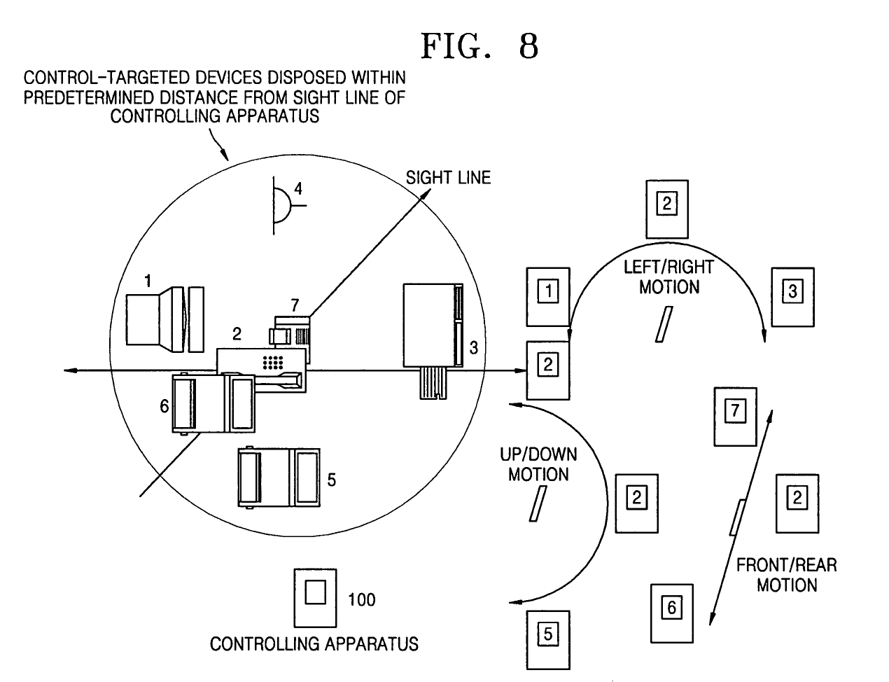

FIG. 8 is a diagram illustrating an exemplary process of secondly selecting the control-targeted device on the basis of the motion of the controlling apparatus, correspondingly to the flowchart of FIG. 7.

In a firstly pointing process, several candidate control-targeted devices 1-7 positioned within a predetermined distance from the sight line of the controlling apparatus 100 are selected. In a secondly pointing process, the control-targeted device, which the user intends to control, among the selected several candidate control-targeted devices 1-7 is selected on the basis of the motion of the controlling apparatus 100. The motion of the controlling apparatus can be measured through the sensor unit 22 of the controlling apparatus 100. If the up or down motion of the controlling apparatus 100 is measured through the sensor unit 22 of the controlling apparatus, the control-targeted device 4 or the control-targeted device 5 is selected. On the other hand, if the front or rear motion of the controlling apparatus 100 is measured, the control-targeted device 7 or the control-targeted device 6 is selected. In the meantime, if the left or right motion of the controlling apparatus 100 is measured, the control-targeted device 1 or the control-targeted device 3 is selected. In the secondly pointing process of the controlling apparatus 100, the candidate control-targeted devices positioned at a periphery of the sight line of the controlling apparatus 100 are sequentially selected depending on the up/down motion, the left/right motion and the front/rear motion.

If the control-targeted device is selected in an aforementioned way, the controlling apparatus 100 generates the control signal for the selected control-targeted device. Generally, the control signal for the selected control-targeted device is generated using a function select button disposed at the controlling apparatus 100.

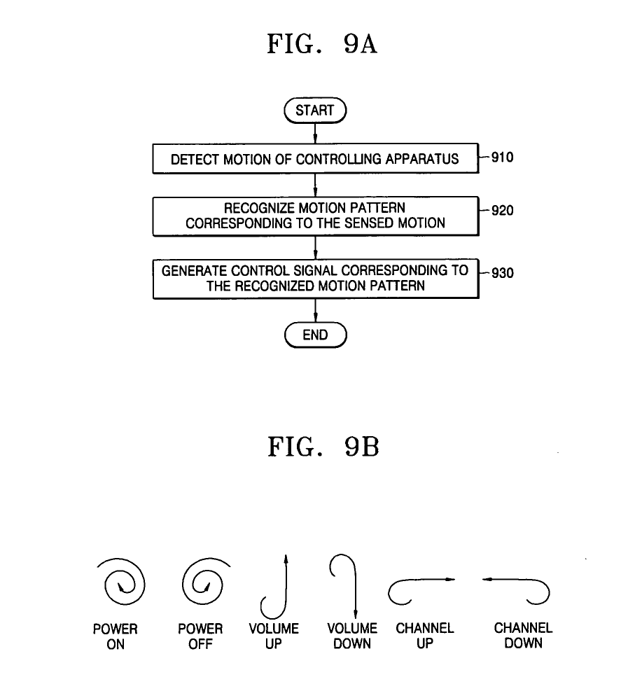

FIG. 9A is a flowchart illustrating a method of generating a control signal by a motion pattern of a controlling apparatus.

In operation 910, the sensor unit 22 of the controlling apparatus is used to sense the motion of the controlling apparatus. In operation 920, the processor unit 52 of the controlling unit 50 recognizes a motion pattern corresponding to the motion of the sensed controlling apparatus 100. In operation 930, the control signal data corresponding to the motion pattern of the recognized controlling apparatus is extracted from the storage media 58 to generate the control signal in the control signal generating unit 56.

FIG. 9B is a view illustrating an exemplary motion pattern, which can be used in a method of generating the control signal by the motion pattern.

A predetermined motion pattern corresponding to the selected control-targeted device and the function corresponding to the motion pattern is displayed on the displaying unit 54. For example, if a television set is selected as the control-targeted device, the motion pattern corresponding to the television set and its corresponding function are displayed on the displaying unit 54 of the controlling apparatus 100. If the user moves the controlling apparatus 100 in clockwise, a function corresponding to a power ON of the television set is inputted. If the user moves the controlling apparatus 100 in counter clock-wise, a function corresponding to a power OFF of the television set is inputted. The predetermined motion pattern and its corresponding control signal may be stored in the storage media 58 of the controlling unit.

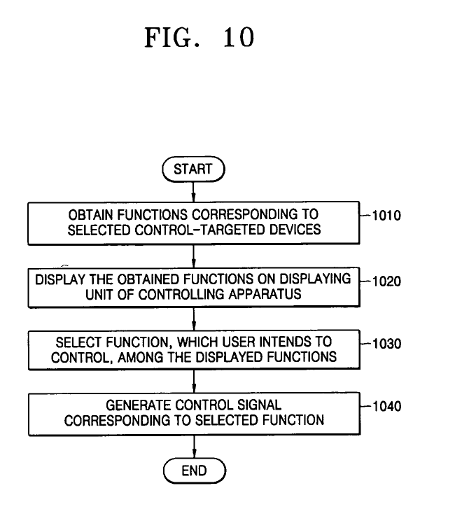

FIG. 10 is a flowchart illustrating a method of generating the predetermined control signal by using the displaying unit of the controlling apparatus.

In a method of controlling the control-targeted device using the displaying unit 54, the displaying unit 54 is comprised of the touch screen. In operation 1010, only a function corresponding to the selected control-targeted device is obtained from the storage media 58. In 1020 operation, the obtained function is displayed on the touch screen 54 of the controlling apparatus 100. In operation 1030, a function, which the user intends to control, among the displayed functions is selected through the touch screen 54. In operation 1040, the control signal corresponding to the function of the selected control-targeted device is generated.

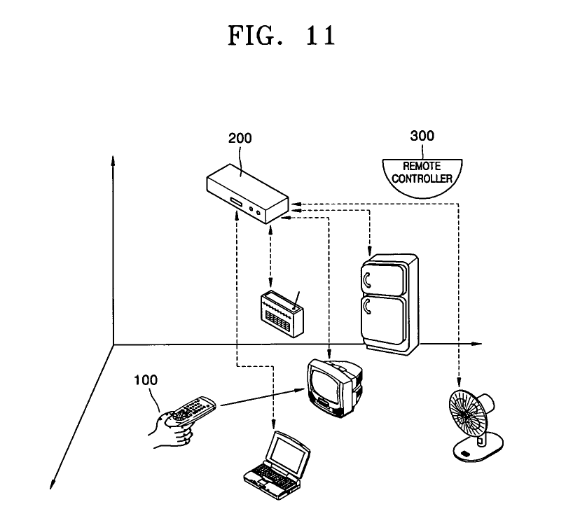

FIG. 11 is a system for controlling the device using the 3D pointing, including the apparatus for controlling the device using 3D pointing, a home server and a remote controller.

The controlling system includes the controlling apparatus 100 for selecting and controlling a predetermined control-targeted device by using the position information of a predetermined control-targeted device and the sight-line information of the controlling apparatus pointing the control-targeted device; a home server 200 for storing the position information of the control-targeted device; and a remote controller 300 for receiving the control signal generated from the controlling apparatus to retransmit the control signal to the selected control-targeted device. The controlling apparatus 100 receives the position information of the control-targeted device from the home server 200 to select a predetermined control-targeted device. A predetermined control signal of the controlling apparatus 100 is directly transmitted or is transmitted through the remote controller 300 to the selected control-targeted device. The remote controller 300 converts the control signal into a signal corresponding to a type of communication of the selected control-targeted device to transmit the converted signal too the selected control-targeted device.

The controlling system transmits the control signal to the selected control-targeted device using different type of communication depending on the environment. Firstly, in a case where there is not an obstacle between the sight line direction pointed by the controlling apparatus 100 and the control-targeted device and the control-targeted device is controlled in a general communication type of the controlling apparatus 100, for example, by using infrared ray or ultrasonic wave, the controlling unit 50 of the controlling apparatus 100 transmits the control signal to the selected control-targeted device through an appropriate protocol.

On the other hand, in a case where there is an obstacle between the control-targeted device and the controlling apparatus 100 or the control-targeted device cannot be controlled in the general communication type of the controlling apparatus 100, the controlling apparatus 100 transmits the control signal for the control-targeted device to the remote controller 300 installed independently. The remote controller 300 retransmits the control signal to the selected control-targeted device, or converts the control signal into a format of a command, which the selected control-targeted device can receive, to transmit the converted control signal in a wire or wireless communication manner supported by the control-targeted device.

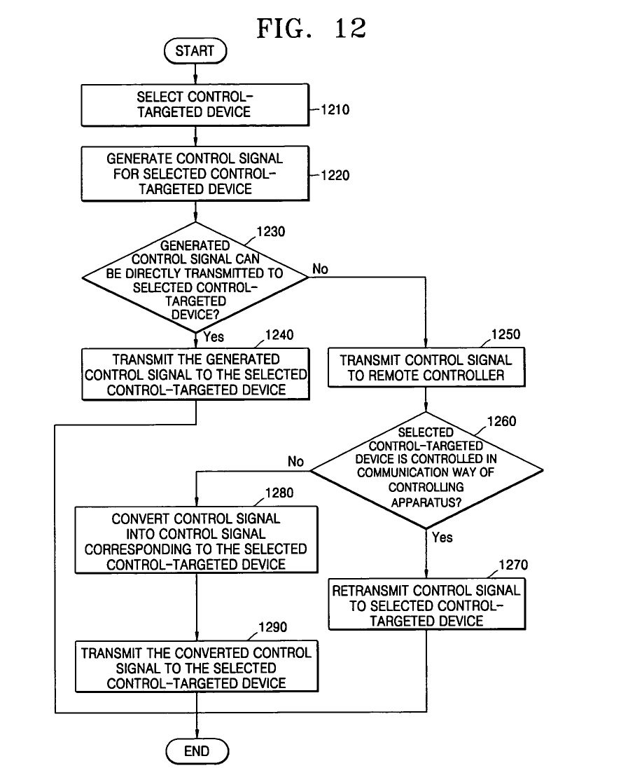

FIG. 12 is a flowchart illustrating a method for transmitting the control signal to the predetermined control-targeted device in the system for controlling the device using the 3D pointing of FIG. 11.

In operation 1210, the control-targeted device is selected. In operation 1220, the control signal for the selected control-targeted device is generated. In operation 1230, it is determined whether or not the control signal of the controlling apparatus is directly transmitted to the control-targeted device. If it is determined that the generated control signal can be directly transmitted to the control-targeted device in operation 1230, the generated control signal is directly transmitted from the controlling apparatus 100 to the selected control-targeted device in operation 1240. However, if it is determined that the generated control signal cannot be directly transmitted to the control-targeted device in operation 1230, the generated control signal is transmitted to the remote controller 300 in operation 1250. In operation 1260, it is determined whether the selected control-targeted device is controlled in the communication type of the controlling apparatus. In a case where the selected control-targeted device is controlled in the communication type of the controlling apparatus 100 in operation 1260, the control signal is retransmitted to the selected control-targeted device in operation 1270. In a case where the selected control-targeted device is not controlled in the communication way of the controlling apparatus 100 in operation 1260, the control signal is converted into a control signal corresponding to the selected control-targeted device in operation 1280. In operation 1290, the converted control signal is transmitted to the selected control-targeted device.

As described above, the present invention can control simply and conveniently the control-targeted device by simply pointing and selecting the control-targeted device, which the user intends to control, among the plurality of control-targeted devices at a home or an office. Further, the controlling apparatus can more precisely control the control-targeted device by selecting the control-targeted device indicated by the controlling apparatus on the basis of the position information and the attitude information of the controlling apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for controlling a control-targeted device using a three dimensional pointing, the method comprising:
calculating position information of a controlling apparatus;
calculating attitude information of the controlling apparatus;
calculating sight line information of the controlling apparatus based on the position information and the attitude information of the controlling apparatus;
selecting the control-targeted device based on the sight line information of the controlling apparatus; and
controlling the control-targeted device.

2. The method of claim 1, wherein in the calculating the position information, a wireless communication protocol Ultra Wide Band is used to calculate the position information of the controlling apparatus.

3. The method of claim 1, wherein the calculating of the attitude information comprises:
calculating a roll angle φ and a pitch angle θ of the controlling apparatus based on the following equation:
$$[ \begin{matrix}ϕ \\ θ\end{matrix} ] = [ \begin{matrix}arctan 2 ( - {A}_{by}^{s} , - {A}_{bz}^{s} ) \\ arctan 2 ( {A}_{bx}^{s} , \sqrt{{( {A}_{by}^{s} )}^{2} + {( {A}_{bz}^{s} )}^{2}}\end{matrix} ]$$
where Aₛ^{bx}, Aₛ^{by}, Aₛ^{bz} are gravitational acceleration measured on a X-axis, a Y-axis, and a Z-axis; and
calculating a Yaw angle of the controlling apparatus based on the following equation:
$$\begin{matrix}[ \begin{matrix}{M}_{nx} \\ {M}_{ny} \\ {M}_{nz}\end{matrix} ] = [ \begin{matrix}cos θ & sin θ sin ϕ & sin θcos ϕ \\ 0 & cos ϕ & - sin ϕ \\ - sin θ & cos θsinϕ & cos θcosϕ\end{matrix} ] [ \begin{matrix}{M}_{bx} \\ {M}_{by} \\ {M}_{bz}\end{matrix} ] and Ψ \\ = {tan}^{- 1} ( \begin{matrix}- {M}_{ny} \\ {M}_{nx}\end{matrix} )\end{matrix}$$
where M_{bx}, M_{by}, M_{bz} are X-axis, Y-axis and Z-axis terrestrial magnetism values of the controlling apparatus measured in a three-axis terrestrial magnetism sensor, and Mₙₓ, M_{ny}, M_{nz} are terrestrial magnetism values of the measured terrestrial magnetism values on a navigation frame.

4. The method of claim 1, wherein the selecting the control-targeted device comprises:
receiving position information of the control-targeted device;
calculating a distance between a sight line of the controlling apparatus and the control-targeted device based on the position information of the control-targeted device; and
selecting the control-targeted device that is positioned at a closest distance to the controlling apparatus among distances between a plurality of control-targeted devices and the controlling apparatus.

5. The method of claim 1, wherein the selecting the control-targeted device comprises:
receiving the position information of the control-targeted device;
calculating a distance between a sight line of the controlling apparatus and the control-targeted device based on the position information of the control-targeted device;
selecting candidate control-targeted devices positioned within a predetermined distance from a sight line of the controlling apparatus; and
selecting the control-targeted device, which a user intends to control, among the candidate control-targeted devices.

6. The method of claim 5, wherein the selecting the control-targeted device among the candidate control-targeted devices comprises:
measuring a motion of the controlling apparatus; and
selecting the control-targeted device corresponding to the measured motion of the controlling apparatus, among the candidate control-targeted devices.

7. The method of claim 5, further comprising displaying the candidate control-targeted devices on a display unit of the controlling apparatus.

8. The method of claim 7, wherein the selecting the control-targeted device among the candidate control-targeted devices further comprises displaying a control-targeted device corresponding to the measured motion of the controlling apparatus, among the candidate control-targeted devices, on the display unit of the controlling apparatus.

9. The method of claim 1, wherein the controlling the control-targeted device comprises:
recognizing a predetermined motion pattern of the controlling device;
generating a control signal corresponding to the predetermined motion pattern of the controlling apparatus; and
transmitting the control signal to the control-targeted device.

10. The method of claim 1, wherein the controlling the control-targeted device comprises:
obtaining functions corresponding to the control-targeted device;
displaying the functions on a display unit of the controlling apparatus;
selecting a specific function among the functions displayed on the display unit;
generating a control signal corresponding to the specific function; and
transmitting the control signal to the control-targeted device.

11. The method of claim 9, wherein in the transmitting the control signal, if there is not an obstacle between the controlling apparatus and the selected control-targeted device and the control-targeted device is controlled using the same type of communication used by the controlling apparatus, the control signal is directly transmitted to the control-targeted device.

12. The method of claim 10, wherein in the transmitting the control signal, if there is not an obstacle between the controlling apparatus and the control-targeted device and the control-targeted device is controlled using the same type of communication used by the controlling apparatus, the control signal is directly transmitted to the control-targeted device.

13. The method of claim 9, wherein the transmitting the control signal comprises:
transmitting the control signal to a remote controller which is separate from the controlling apparatus if there is an obstacle between the controlling apparatus and the control-targeted device; and
transmitting the control signal from the remote controller to the control-targeted device.

14. The method of claim 10, wherein the transmitting the control signal comprises:
transmitting the control signal to a remote controller separate from the controlling apparatus if there is an obstacle between the controlling apparatus and the control-targeted device; and
transmitting the control signal from the remote controller to the control-targeted device.

15. The method of claim 9, wherein the transmitting the control signal comprises:
transmitting the control signal to a remote controller separate from the controlling apparatus if the control-targeted device and the controlling apparatus utilize different types of communication;
converting the control signal into a converted control signal corresponding to a communication type of the control-targeted device; and
transmitting the converted control signal to the control-targeted device.

16. The method of claim 10, wherein the transmitting the control signal comprises:
transmitting the control signal to a remote controller separate from the controlling apparatus if the selected control-targeted device and the controlling apparatus utilize different types of communication;
converting the control signal into a converted control signal corresponding to a communication type of the control-targeted device; and
transmitting the converted control signal to the control-targeted device.

17. An apparatus for controlling a control-targeted device using a three dimensional pointing, the apparatus comprising:
a position calculating unit which calculates position information of a controlling apparatus;
an attitude calculating unit which calculates attitude information of the controlling apparatus;
a sight-line calculating unit which calculates sight-line information of the controlling apparatus based on the position information and the attitude information of the controlling apparatus;
a control-targeted device selecting unit which selects the control-targeted device based on the sight line information of the controlling apparatus; and
a controlling unit which controls the control-targeted device.

18. The apparatus of claim 17, wherein the position calculating unit uses a wireless communication protocol Ultra Wide Band to calculate the position information of the controlling apparatus.

19. The apparatus of claim 17, wherein the control-targeted device selecting unit comprises:
a storage media which stores the position information of the control-targeted device;
a distance calculating unit which calculates a distance from a sight line of the controlling apparatus to the control-targeted device based on the position information of the control-targeted device; and
a control-targeted device detecting unit which detects a control-targeted device disposed at a closest distance from the sight line of the controlling apparatus based on the distance calculated by the distance calculating unit.

20. The apparatus of claim 17, wherein the attitude calculating unit comprises:
a sensor unit which measures an attitude value of the controlling apparatus; and
a processor unit which calculates the attitude information of the controlling apparatus based on the measure attitude value.

21. The apparatus of claim 20, wherein the sensor unit comprises a three-axis acceleration sensor and a three-axis terrestrial magnetism sensor.

22. The apparatus of claim 17, wherein the controlling unit comprises:
a display unit which displays a control state of the controlling apparatus;
a storage media which stores functions of a plurality of control-targeted devices and control signal data corresponding to the functions;
a control signal generating unit which generates a control signal based on the control signal data corresponding to a predetermined function of the control-targeted device; and
a processor unit which controls the display unit, the storage media and the control signal generating unit.

23. A system for controlling a control-targeted device using a three dimensional pointing, the system comprising:
a controlling apparatus; and
a home server which stores position information of the control-targeted device,
wherein the controlling apparatus comprises:
a position calculating unit which calculates position information of the controlling apparatus;
an attitude calculating unit which calculates attitude information of the controlling apparatus;
a sight-line calculating unit which calculates sight-line information of the controlling apparatus based on the position information and the attitude information of the controlling apparatus;
a control-targeted device selecting unit which selects the control-targeted device based on the sight line information of the controlling apparatus; and
a controlling unit which controls the control-targeted device.

24. A system for controlling a control-targeted device using a three dimensional pointing, the system comprising:
a controlling apparatus which selects and controls a control-targeted device based on position information of the control-targeted device and sight-line information of the controlling apparatus pointing the control-targeted device;
a home server which stores the position information of the control-targeted device; and
a remote controller which receives a control signal generated by the controlling apparatus and transmits the control signal to the control-targeted device.

25. The system of claim 24, wherein the remote controller converts the control signal into a converted control signal that can be received by the control-targeted device and transmits the converted signal to the control-targeted device.
